(19) United States
(12) Patent Application Publication
(10) Pub. No.: US 2008/0182019 A1
(43) Pub. Date: Jul. 31, 2008

(54) Hollow Microsphere Particle Generator

(76) Inventors: Robert Retter, Buena Park, CA (US); Michael Bell, Fullerton, CA (US)

Correspondence Address: Townsend and Townsend and Crew LLP, Two Embarcadero Center, 8th Floor, San Francisco, CA, 94111, US

(21) Appl. No.: 11/669,058

(22) Filed: Jan. 30, 2007

(51) Int. Cl. B05D 7/00

(52) U.S. Cl. 427/214; 264/7

(57) ABSTRACT

A hollow microsphere particle generator comprising at least one inlet for receiving at least one shell fluid; an inlet for receiving a core fluid, an inlet for receiving a sheath fluid; a fluid outlet, from which the at least one shell fluid and the core fluid exit in a continuous stream arranged such that the core fluid coaxially covered by the at least one shell fluid to form a continuous casting stream; and a discretizer capable of discretizing the continuous casting stream into discrete units to form the hollow spherical particles. The at least one shell fluid and the core fluid form the continuous coaxial casting fluid stream that exits at the fluid outlet. The casting fluid stream is discretized upon exiting the outlet, and dispensed into a sheathing fluid stream formed from the sheathing fluid such that exposure to air is prevented.

### FIELD OF THE INVENTION

The present invention, in general, relates to the production of uniform dimensioned particles, and more particularly, novel apparatus and methodology for producing uniform dimensioned spheres of minute sizes from various materials.

### BACKGROUND OF THE INVENTION

Nano and micro scale hollow spherical particles have attracted considerable attention in recent years. They have great potential utilities in material science and medicine. Both inorganic and polymeric hollow microspheres having a general core-shell structure have been reported in the literature. For example, Tan et al. have reported the fabrication of double-walled microspheres for the sustained release of doxorubicin (Journal of Colloid Interface Sci. 291, 135-143), and Pekarek et al. have reported double-walled polymer microspheres for controlled drug release (Nature 367, 258-260).

Among the published microspheres, hollow microsphere particles made from metal (e.g. gold), metal oxides (e.g. Al₂O₃, TiO₂, ZrO₂), silica, polymers (e.g. poly(methylmethacrylate), poly(N-isopropylacrylamide), polyorganosiloxane, poly(acrylamide)/poly(acrylic acid) (PAAM/PAAC), poly(styrene), poly(3,4-ethylenedioxythiophene) (PEDOT), polyaniline (PANI), polypyrrole (PPY) and composites (e.g. ZnS, CdS) have been fabricated with various diameters and wall thickness.

Prior art methods for generating core-shell microspheres generally involve either physiochemical or chemical processes. In the former, an organic or inorganic substance is precipitated at the core interface during solvent evaporation or adsorption by means of electrostatic or chemical interactions. In the latter, the fabrication of core-shell particles by chemical processes utilizes various multi-step polymerization reactions. The first step is to prepare seeds (templates) such as polymer beads, colloids, surfactant vesicles, emulsion droplets, or amphiphilic diblock polymers. Subsequently, a monomer is added and polymerized via emulsion, microemulsion, or suspension methods. Calcinations or solvent etching is used to remove the template materials. In most cases, however, the formation of a uniform shell surrounding the core, as well as control of the shell thickness are difficult to achieve because polymerization can not be restricted to the surface of the templates.

Although the templating method is commonly used for preparing core-shell hollow particles, capabilities of this approach is very limited because, in most cases, the material(s) that need to be encapsulated in the microspheres are not suitable templates. In fact, the majority of studies were devoted to investigating the morphology of the core-shell microspheres.

Im et al. (Nature Mater. 4, 671-675 (2005)) have reported on the preparation of macroporous capsules-polymer shells with controllable holes in their surfaces, which may be useful for incorporating chemically more labile proteins. However, after loading with functional materials, these holes must be closed by thermal annealing (95° C.) or by solvent treatment. Such conditions are often harsh for the encapsulated cargo, and may cause damage of the cargo (e.g. denaturation of proteins).

Therefore, there still exists a need for a method that can generate hollow microsphere particles with an uniform dimension under mild, chemically non-reactive conditions.

### SUMMARY OF THE INVENTION

Accordingly, one aspect of the present invention provides a novel apparatus capable of generating uniform sized hollow microsphere particles under mild conditions, comprising:

a body and a plurality of fluid passageways contained therein;

at least one first inlet for receiving at least one shell fluid, wherein the at least first inlet is adapted to or integrally formed on the body and is in fluid communication with at least one fluid passageway;

a second inlet for receiving a core fluid, wherein the second inlet is adapted to or integrally formed on the body and is in fluid communication with a fluid passageway;

a third inlet for receiving a sheath fluid, wherein the third inlet is adapted to or integrally formed on the body and is in fluid communication with a fluid passageway;

a fluid outlet adapted to or integrally formed on the body and is in fluid communication with the plurality of fluid passageways from which the at least one shell fluid and the core fluid enter via the first and second fluid inlet and exit via the fluid outlet in a continuous stream to form a continuous casting stream such that the core fluid is coaxially covered by the at least one shell fluid; and

a discretizer capable of discretizing the continuous casting stream into discrete units to form hollow spherical particles, wherein the casting fluid stream is discretized by the discretizer upon exiting the outlet, and wherein upon being discretized, the discrete units are dispensed into a sheathing fluid stream formed from the sheath fluid such that exposure to air is prevented.

In another aspect, the present invention provides a method for casting hollow particles with a first component core and a second component shell, comprising the steps of

forming a coaxial stream of particle casting fluid, wherein the stream is comprised of a core fluid sheathed by at least one layer of at least one shell fluid;

forming at least one hollow particle by breaking the stream of casting fluid into discrete unit(s) of fluid, wherein the discrete unit(s) of fluid form a spherically shaped hollow particle completely sheathed by a layer of shell fluid so as to form a shell-and-core structure; and

disposing the at least one hollow particle in a sheath fluid immediately upon formation so as to prevent exposing the particle to adverse environments,

wherein the particles are formed under non-reactive conditions.

Other aspects and advantages of the invention will be apparent from the following description and the appended claims.

### BRIEF DESCRIPTION OF THE DRAWINGS

FIG. 1 shows a schematics representation of an apparatus according to one aspect of the present invention.

FIG. 2 shows a perspective view of an exemplary embodiment of the apparatus according to one aspect of the present invention.

FIG. 3 shows a cross-sectional view of the apparatus of FIG. 2. The figure shows the upper portion and the lower portion of the apparatus, omitting the middle extension portion connecting the upper and the lower portion.

FIG. 4 shows a strobed image of a hollow microsphere particle casting stream against an LED bar driven at the same frequency as the piezoelectric vibrator

FIG. 5 shows fluorescence images of three polystyrene microspheres doped with the hydrophilic dye HPTS (green, in the core) and lipophilic DiIC18 (red, in the shell) deposited on a glass support.

### DETAILED DESCRIPTION

The present invention will now be described in detail by referring to specific embodiments as illustrated in the accompanying figures.

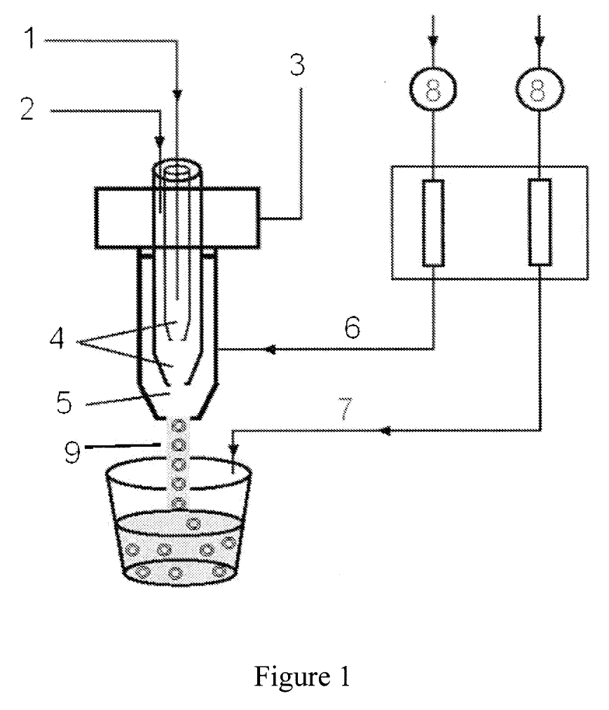

Referring first to FIG. 1, there is illustrated a schematics representation of an exemplary embodiment of an apparatus for generating hollow microsphere particles according to one aspect of the present invention. An apparatus of the present invention generally comprises:

(1) a body having a plurality of fluid passageways contained therein;

(2) at least one first inlet for receiving at least one shell solution, wherein the first inlet is adapted to or integrally formed on the body and is in fluid communication with at least one fluid passageway;

(3) a second inlet for receiving a core fluid, wherein the second inlet is adapted to or integrally formed on the body and is in fluid communication with a fluid passageway;

(4) a third inlet for receiving a sheath fluid, wherein the third inlet is adapted to or integrally formed on the body and is in fluid communication with a fluid passageway;

(5) a fluid outlet adapted to or integrally formed on the body and is in fluid communication with the plurality of fluid passageways from which the at least one shell fluid and the core fluid enter via the first and the second inlet and exit via the outlet to form a continuous casting fluid stream such that the core fluid is coaxially covered by the at least one shell fluid; and

(5) a discretizer capable of discretizing the continuous casting stream into discrete units to form hollow spherical particles.

The body of the apparatus provides a structural framework for the various components to be assembled. The specific form and shape of the body is not essential so long as the it can provide a structural framework for the various components of the apparatus to form an integrated whole.

The main function of the fluid inlets is to direct the core and shell fluid into a continuous stream. One skilled in the relevant art will readily recognize that any suitable fluid conducting means commonly known in the art may be used so long as the materials of the inlets are not reactive with the respective fluids. In one embodiment, the core fluid inlet may comprise a hollow tube and the shell fluid inlet may comprise a lumen around the hollow tube of the core fluid inlet for directing the shell fluid into a coaxial sheath around the core fluid as shown in FIG. 1.

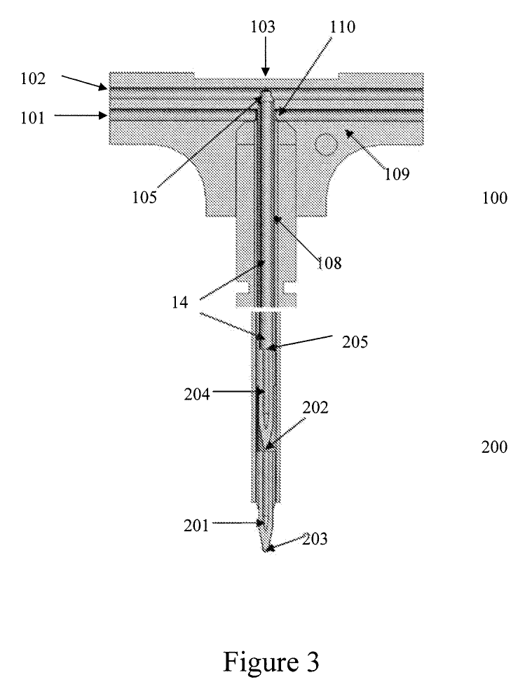

The main function of the fluid outlet is to direct the formation and flow of the casting fluid stream. In one embodiment, the fluid outlet comprises a pair of coaxially arranged tips consisting of a first tip for transmitting the core fluid and a second tip for transmitting the shell fluid. The tips each have an receiving end and an ejecting end for receiving and ejecting the fluids. As shown in FIG. 1, the two tips are telescoped one within the other. However, this concentric arrangement is merely for illustrative purpose. The tips need not be arranged concentrically as shown in the figure. In fact, it is preferred that the tips are not arranged concentrically as shown in FIG. 1, but rather, arranged coaxially (as shown in FIG. 3, 204 and 201). In one preferred embodiment, the tips are tapered on the ejecting end so that the ejecting end of one tip may be partially inserted into the receiving end of another tip to achieve the preferred coaxial arrangement. In this way, there need not be distinctions between the different tips so that all tips may be interchangeable, thereby, avoiding the need to have different shaped/sized tips for forming the fluid outlet.

A variety of commercially available tips may be used for forming the outlet as described above. Exemplary types of tips may include, but not limited to capillary tips, wire bonding tips, formed ceramic tips, and formed glass tips. Alternatively, custom-made tips may also be used.

The tips may be manufactured from a variety of materials so long as they have the properties of smoothness, rigidity, non-porosity, solvent resistance, and dimensional stability. Exemplary materials may include, but not limited to ceramics, sapphire, glass, metal and a polymeric material such as PEEK.

The openings of the tips (both receiving end and ejecting end) preferably have an aperture in the range of from about 1 μm to about 1 mm, more preferably from about 10 μm to about 50 mm. In one embodiment, the receiving end has a larger aperture than the ejecting end.

Referring again to FIG. 1, uniform sized hollow microsphere particles may be formed by an apparatus of the present invention as follows. A core solution 1 and a shell solution 2 are received by the apparatus from syringe pumps (not shown) and are passed through a conduit within the body of the particle generator.

A pair of coaxially arranged ceramic flow tips 4 may be mounted on the exiting end of the particle generator conduit for shaping the exiting stream. The core solution stream 1 is directed through a first tip and then into a second tip, and the shell solution 2 is directed into the second tip such that it surrounds the core stream from the first tip entering through the space between the first tip and the second tip. As the combined streams exit the second tip, the shell solution stream 2 contacts the core solution stream 1 to form a sheath enveloping the core solution stream in a coaxial arrangement. The combined stream forms the casting fluid stream for casting the hollow microsphere particles.

This coaxial core-shell microsphere particle casting stream is then discretized by a frequency generator 3 mounted on the particle generator. In one embodiment, the frequency generator is a vibrator that vibrates the ceramic nozzles 4 at high frequency to break the emerging casting fluid stream into discrete droplets, thereby “discretizing” the casting fluid stream into individual core-shell microsphere particles. In other embodiments, the discretizer may be any device that can impart a periodic oscillation to the tips so as to break the stream evenly into uniform “chunks” to form nascent hollow microsphere particles. Exemplary discretizers may include, but not limited to magnetorestrictive vibrators, electret vibrators, voice coil vibrators, thermal vibrators, mechanical vibrators, or any other suitable vibrators commonly known in the art.

A pressurized solution bottle (not shown) regulated by a pressure regulator 8 may also be connected to the particle generator for providing a sheath fluid. When the casting fluid stream is discretized, the nascent microsphere particles are first suspended in the sheath fluid inside a suspension chamber 5. The sheath fluid functions both as a protective sheath to prevent the nascent microsphere particles from being exposed to air and also as a carrier solution to carry the hollow microsphere particles to a destination (e.g. a collection vial). In one embodiment, the sheath fluid is preferably deionized water.

Preferably, the various stream of fluids (i.e. the shell streams, the core stream, and the sheath stream) all converge under laminar flow conditions so that the nascent microsphere particles do not become “mixed” with the sheath fluid, but are merely suspended in the sheath fluid. The carrier/sheath fluid then forms a sheath around the nascent microsphere particles for carrying the particles in a continuous flow from the suspension chamber 5 into a collection vial placed below the tips. In this way, the nascent microsphere particles are carried from the suspension chamber to the collection vial in a continuous flow of protective aqueous carrier stream 9 without being exposed to air.

Additional layers of shells may be optionally added to the hollow microspheres by adding additional inlets to direct additional shell fluids into the apparatus and by adding corresponding additional number of tips coaxially arranged so as to direct the addition shell fluids to form additional shell layers around the core fluid.

Hollow microsphere particles generated by an apparatus of the present invention will preferably have a uniform size in the range of from about 0.1 μm to about 100 μm, more preferably from about 2 μm to 20 μm, and preferably have a size variation of less than 5%, more preferably less than 1%.

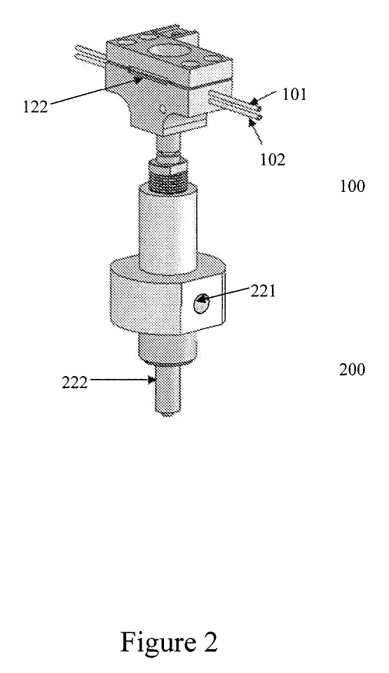

To further illustrate the apparatus of the present invention, FIG. 2 and FIG. 3 show a specific exemplary design of a hollow microsphere particle generator according to one embodiment of the present invention.

Referring to FIG. 2, the upper portion 100 of the apparatus body forms a head that comprises the fluid inlets 101 and 102 for receiving the core fluid and the shell fluid. The fluid inlets 101 and 102 are each in fluid communication with the internal fluid passageways. A piezoelectric vibrator 122 is mounted to the apparatus at the coupling surface 103 (FIG. 3) of the head. Shell fluid, typically a hydrophobic polymer dissolved in organic solvent such as dichloromethane, enters the apparatus through inlet 101. Core fluid, typically an aqueous solution, enters the apparatus through inlet 102. Sheath fluid, typically deionized water, enters the apparatus through inlet 221.

FIG. 3 shows the internal structure of the apparatus. Referring to FIG. 3, inlet 102 communicates at junction 105 to tube 14 (a fluid passageway) which transmits the core fluid to upper ceramic tip 204. Tube 14 abuts upper ceramic tip 204 at junction 205, and the lumen of tube 14 communicates with the lumen (another fluid passageway) of upper ceramic tip 204. Each of upper ceramic tip 204 and lower ceramic tip 201 has a lumen that completely penetrates the tip, but is too small in the region of the tip extremity (202 and 203) to be visible in the illustration. Diameter of the lumen in the ceramic tips is typically on the order of tens of micrometers. Flow through these narrow apertures reduces the diameter and increases the velocity of the stream. The ceramic tips are normally wire bonding tips, chosen for their strength, precision of construction, solvent resistance, and surface finish.

Tube 14 is contained within an extended cavity in the apparatus forming a coaxial lumen 108 around tube 14. Inlet 101 communicates with this lumen at junction 110, allowing transmission of shell fluid past upper ceramic tip 202 to the lumen of lower ceramic tip 203. The extremity 202 of upper ceramic tip 204 is in close proximity to the lumen of lower ceramic tip 201 and preferably extends slightly into that lumen, directing the flow of core fluid down the center of lower ceramic tip 201. Shell fluid transmitted by coaxial lumen 108 enters the lumen of lower ceramic tip and forms a coaxial shell sheath stream surrounding the core fluid.

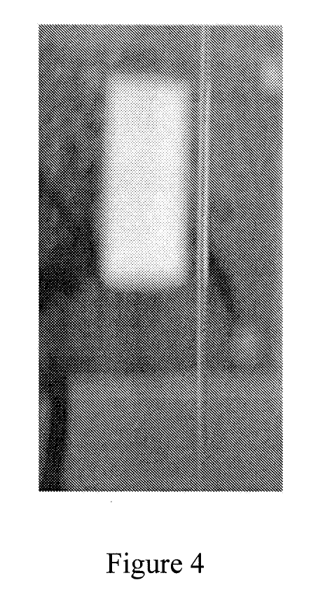

The piezoelectric vibrator 122 mounted at the coupling surface 103 vibrates the combined core and shell stream, causing it to break up into discrete droplets after the stream emerges from the lower ceramic tip and enter suspension chamber 222. Sheath fluid entering the apparatus at inlet 221 communicates with the suspension chamber 222 and forms an unbroken sheath coaxial with the stream of droplets. This compound stream exits the suspension chamber and flows through air to the collection vial. FIG. 4 shows a strobed image of the compound fluid stream against an LED bar driven at the same frequency as the piezoelectric vibrator.

In the collection vial, solvents in the shell of each droplet gradually evolve out of the droplet, leaving a uniform polymer shell surrounding the aqueous core. A slow addition of a surfactant solution helps retard particle cohesion during this curing process. Several changes of surrounding water may be necessary to fully cure the particles. Materials originally present in the core and shell streams, provided they have minimal solubility in the adjacent phases during the curing process, remain within the finished particles.

The physical properties of the particles the device produces depends on the constituents of the core and shell streams, on their flow rates, and on the frequency of the piezoelectric vibration. Higher vibration frequencies at fixed flow rates create smaller particles. Higher flow rates of core stream with respect to shell stream increase the size of the particle cores.

Thus, as illustrated above, an apparatus according to embodiments of the present invention represents a novel apparatus that is capable of generating hollow microsphere particles having substantially uniform dimensions under mild, non-reactive conditions. The fact that the particles may be generated under mild, non-reactive conditions obviates the need for employing reactive conditions required in prior art methods. Accordingly, in another aspect, the present invention also provides a novel method for casting hollow microsphere particles having a core-shell structure.

A method according to this aspect of the present invention generally comprises the steps of:
(1) forming a coaxial stream of particle casting fluid, wherein the stream is comprised of a core fluid sheathed by at least one layer of at least one shell fluid;
(2) forming at least one hollow particle by breaking the stream of casting fluid into discrete unit(s) of fluid, wherein the discrete unit(s) of fluid form a spherically shaped hollow particle completely sheathed by a layer of shell fluid so as to form a shell-and-core structure; and
(3) disposing the at least one hollow particle in a sheath fluid immediately upon formation so as to prevent exposing the particle to adverse environments,
   wherein the particles are formed under non-reactive conditions.

The core fluid is typically comprised of an aqueous solution. In some embodiments, the core fluid may be comprised of a hydrophilic solvent having a polymer dissolved therein.

The shell fluids is typically comprised of a polymeric material.

Exemplary polymeric material may include, but not limited to plasticized polyvinyl chloride, polyurethane, polystyrene, co-poly(methyl methacrylate-decy methacrylate), poly(butyl acrylate), co-poly(styrene-maleic anhydride), or any combinations thereof.

Core and shell fluids may further contain dopants or inclusions such as dyes, ligands, ions, particles, magnetic materials, transport agents, pharmaceuticals, cells or catalysts.

In some embodiments, the particles may be nanoparticles such as cross-linked polystyrene particles preloaded with dye, quantum dot nanocrystals, or nanocrystals of up-converting phosphors.

In some embodiments, the polymeric materials may further include moieties that permit subsequent modification of formed particles, such as the covalent attachment of biological ligands to particle surfaces. Examples of the polymer material with modifiable side-chain moieties may include, but not limited to co-poly(styrene-maleic anhydride). This moiety has available carboxyl groups suitable for later chemical modification, e.g. binding of antibodies using conventional EDAC binding chemistry.

In one embodiment, dopants of the core fluid may include, but not limited to a fluorescent dye, a biological molecule, a pH indicator, a fluorescent quencher, a preformed particle, cells, and a pharmaceutical. Because the method of forming the hollow microsphere particles is carried out under mild, non-reactive conditions, a fragile dopant (or cargo) may be advantageously included without substantially altering the structure or property of the dopant.

The sheath fluid is typically a non-reactive solution. Depending on the chemical nature of the core and shell fluids, one skilled in the relevant art will readily be able to select a corresponding non-reactive fluid as the sheath fluid. For example, in one embodiment, the shell fluid is a polystyrene and the sheath fluid is preferably deionized water. Surfactants such as soap may also be advantageously included in the sheath fluid to prevent aggregation of the nascent hollow microsphere particles. In some embodiments, non-reactive buffers may also be beneficially used as a sheath fluid.

To break the stream of casting fluid into discrete units, any number of means commonly known in the art may be used. In one embodiment, a preferred means for breaking the stream of casting fluid is a device capable of imparting periodic oscillation to the stream (or conduit of the stream) such that the amplitude of the oscillation is capable of breaking the stream into uniform sized droplets. Piezoelectric vibrators are excellent exemplary devices for this purpose.

To further control the size and shell thickness of the resulting hollow microsphere particles, the vibrator frequency and flow rate for each of the core an shell fluids may be adjusted to achieve the desired result.

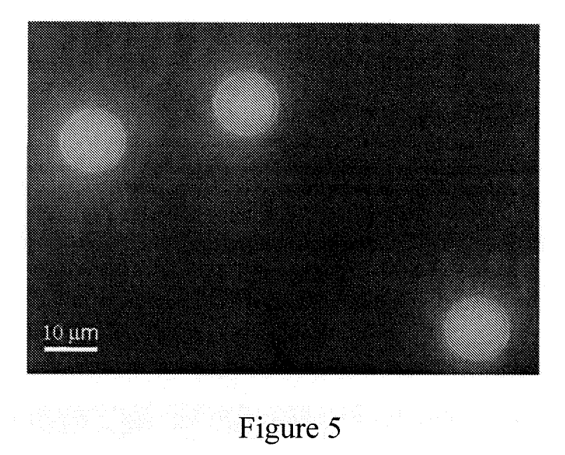

As an example of the uniform sized hollow microsphere particles produced by the method and apparatus disclosed herein, FIG. 5 shows fluorescence images of three polystyrene microspheres doped with the hydrophilic dye HPTS (green, in the core) and lipophilic DiIC18 (red, in the shell) deposited on a glass support. The clear distinction between the fluorescent regions shows the regular structure and size of the particles.

Apparatuses and methods of the present invention have at least the following advantages. In general, apparatuses and methods of the present invention improve uniformity of the hollow microsphere particles, and enable the precise control of proportions of core and shell in the particles. The mild conditions also allow sensitive and fragile materials (such as active biological materials or substances subject to redox reactions in air) to retain their structure and functionality.

In the apparatuses of this invention, the concentric core/shell droplets are contained within a continuous sheath flow. The droplets do not contact air and are thus protected from any direct interaction with air. They are further protected from possibly disrupting impact at the collection vial, and from the effects of surface tension at the vial surface which might otherwise trap some or all of the nascent particles at an air water interface, thereby creating nonuniformities in the particle population. There is also no need to supply an external fluid to suspend the particles in the collection vial; the sheath liquid suffices.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. An apparatus for generating hollow spherical particles, comprising:
a body and a plurality of fluid passageways contained there;
at least one first inlet for receiving at least one shell fluid, wherein the at least one first inlet is adapted to or integrally formed on the body and is in fluid communication with at least one fluid passageway;
a second inlet for receiving a core fluid, wherein the second inlet is adapted to or integrally formed on the body and is in fluid communication with a fluid passageway;
a third inlet for receiving a sheath fluid, wherein the third inlet is adapted to or integrally formed on the body and is in fluid communication with a fluid passageway;
a fluid outlet adapted to or integrally formed on the body and is in fluid communication with the plurality of passagways from which the at least one shell fluid and the core fluid enter via the first and the second inlet and exit via the outlet to form a continuous casting fluid such that in a continuous stream arranged such that the core fluid is coaxially covered by the at least one shell fluid; and
a discretizer capable of discretizing the continuous casting stream into discrete units to form the hollow spherical particles,
wherein the casting fluid stream is discretized by the discretizer upon exiting the outlet, and wherein upon being discretized, the discrete units are dispensed into a sheathing fluid stream formed from the sheath fluid such that exposure to air is prevented.

2. The apparatus of claim 1, wherein the core fluid inlet comprises a hollow tube for directing the core fluid into a continuous stream and the shell fluid inlet comprises a lumen around the hollow tube of the core fluid inlet for directing the shell fluid into a coaxial sheath around the core fluid.

3. The apparatus of claim 1, wherein the fluid outlet comprises a pair of coaxially arranged tips consisting of a first tip for transmitting the core fluid and a second tip for transmitting the shell fluid, each tip having an receiving end and an ejecting end for receiving and ejecting the fluids, whereby the core fluid is transmitted directly through a center passage of the first tip while the shell fluid is transmitted through a lumen formed between the first and the second tips.

4. The apparatus of claim 3, wherein the tips are selected from the group consisting of capillary tips, wire bonding tips, formed ceramic tips, and formed glass tips, and wherein the tips are formed from a material selected from the group consisting of ceramics, sapphire, glass, metal, and a polymer.

5. The apparatus of claim 3, wherein the ejecting end of the first tip has a circular aperture with a diameter in the range of from about 1 μm to about 1 mm, and the ejecting end of the second tip has a circular aperture with a diameter in the range of from about 1 μm to about 1 mm.

6. The apparatus of claim 3, further comprising addition inlets for additional shell fluids and corresponding additional tips coaxially arranged so as to direct the additional shell fluids to form additional concentric layers around the core fluid.

7. The apparatus of claim 3, further comprising a suspension chamber located below the ejecting end of the tips for providing a fluid retention space in which the hollow particles into the sheathing fluid.

8. The apparatus of claim 1, wherein the discretizer is one selected from the group consisting of a piezoelectric vibrator, magnetorestrictive vibrator, an electret vibrator, a voice coil vibrator, a thermal vibrator, and a mechanical vibrator.

9. The apparatus of claim 1, further comprising a flow regulator for regulating the flow rate of the fluids.

10. The apparatus of claim 1, further comprising a strobe light imager for monitoring the ejected hollow particles.

11. The apparatus of claim 1, wherein the apparatus is capable of generating monodispersed hollow particles having a size in the range of about 0.1 μm to about 100 μm and a size variation of less than 5%.

12. A method for casting hollow microsphere particles having a first component core and a second component shell, comprising:
forming a coaxial stream of particle casting fluid, wherein the stream is comprised of a core fluid sheathed by at least one layer of at least one shell fluid;
forming at least one hollow particle by breaking the stream of casting fluid into discrete unit(s) of fluid, wherein the discrete unit(s) of fluid form a spherically shaped hollow particle completely sheathed by a layer of shell fluid so as to form a shell-and-core structure; and
disposing the at least one hollow particle in a sheath fluid immediately upon formation so as to prevent exposing the particle to adverse environments
wherein the particles are formed under non-reactive conditions.

13. The method of claim 12, wherein the at least one shell fluid is a polymer material.

14. The method of claim 13, wherein the polymer material is one selected from the group consisting of plasticized polyvinyl chloride, polyurethane, polystyrene, co-poly(methyl methacrylate-decy methacrylate), poly(butyl acrylate), co-poly(styrene-maleic anhydride), and combinations thereof.

15. The method of claim 13, wherein the at least one shell fluid further comprises a dopant selected from the group consisting of dyes, ligands, ions, particles, nanoparticles, magnetic materials, transport agents, cells, pharmaceuticals, and catalysts.

16. The method of claim 13, wherein the polymer material of the shell fluid further comprises modifiable side-chain moieties for later chemical modification.

17. The method of claim 12, wherein the core fluid is comprised of a hydrophilic solvent having a polymer dissolved therein.

18. The method of claim 12, wherein the core fluid further comprises a dopant selected from the group consisting of a fluorescent dye, a biological molecule, a pH indicator, a fluorescent quencher, a preformed particle, cells, and a pharmaceutical, and whereby the non-reactive condition of the method allows a fragile dopant to be included without substantially altering its structure or property.

19. The method of claim 12, wherein the sheath fluid is one selected from deionized water, deionized water with a surfactant, or a buffer.

20. The method of claim 12, further comprising a step of collecting the hollow particles and sheath fluid stream in a collector

21. The method of claim 12, further comprising the step of controlling the particle's size and shell thickness by setting a vibration frequency and a flow rate for each of the core and shell fluids.

22. The method of claim 21, wherein the vibration frequency is generated by a piezoelectric vibrator.
